(19) United States
(12) Patent Application Publication
(10) Pub. No.: US 2018/0066633 A1
(43) Pub. Date: Mar. 8, 2018

(54) Method and means for mounting wind turbines upon a column

(71) Applicant: Matteo Bojanovich, Galway, NY (US)

(72) Inventor: Matteo Bojanovich, Galway, NY (US)

(21) Appl. No.: 15/671,659

(22) Filed: Aug. 8, 2017

Related U.S. Application Data
(63) Continuation-in-part of application No. 14/922,056, filed on Oct. 23, 2015, now abandoned.

(51) Int. Cl. F03D 13/20; F03D 7/02

(52) U.S. Cl. CPC F03D 13/20; F05B 2240/915; F03D 7/0268

(57) ABSTRACT

A variable level, relatively mobile wind power system consists of small, personal use wind turbines mounted upon an axis without need for a concrete mounting platform. As needed, the axis may be brought to the desired level upon a column and retracted to the ground for servicing. The entire wind power system can also be easily transferred to a different location.

### CROSS REFERENCE TO RELATED APPLICATION

This application is a continuation-in-part of application Ser. No. 14/921,056, filed on Oct. 23, 2015, the disclosure of which is incorporated by reference herein.

### FIELD OF THE INVENTION

The present invention relates to a method and means for mounting wind turbines at different levels of a supporting column.

### BACKGROUND OF THE INVENTION

A major issue in regard to wind turbines is the likelihood of damage to the turbine and its tower during storms. The preferred solution has been to engineer constructions so massive as to be likely to withstand historically experienced storms. This solution has not eliminated catastrophic failure. Moreover, it resulted in prohibitive setup costs. Thus wind power, as currently in use throughout the world, involves very high start-up costs. Massive foundations and towers are required as well as cranes. As a result, wind power is not competitive with fossil fuel power generation systems.

Wind speed usually increases and turbulence decreases with height from the ground. Since 1904, engineers have proposed variable level turbines that would allow for simplified installation and maintenance.

In 1904, U.S. Pat. No. 756,216 (Crunican) disclosed a wind turbine, with a “vertically adjusted . . . wind-wheel and attachments” which will “automatically lower themselves when acted upon by wind traveling at a rate of speed in excess of that necessary to operate.”

In 1939, U.S. Pat. No. 2,177,801 (Erren) disclosed a “wind driven generator mounted on a telescopic mounting for adjustment n respect to height.”

In 1981, U.S. Pat. No. 4,266,911 (Helm et al.) disclosed “a wind power plant . . . including a power house and vanes rotatable by the wind . . . assembled on the ground . . . the power system is then elevated . . . along the tower . . . with cables and a winch.”

In January 1982, U.S. Pat. No. 4,311,434 (Abe) disclosed “a freely liftable . . . nacelle which is fitted with a propeller wind wheel . . . the nacelle can be lowered to the ground to protect . . . from breakage due to the force of the wind. Required maintenance and inspection—of the nacelle and replacement of rotor blades—can be safely carried out on the ground.”

In August 1982, U.S. Pat. No. 4,342,539 (Potter) disclosed a “retractable wind machine . . . . The tiltable windmill rotating mast is a telescoping tower, which is retracted into storage mode, usually during dangerous windstorms.”

In October 1986, U.S. Pat. No. 4,616,974 (Andruszkiw et al.) disclosed “a wind driven power generating apparatus . . . automatically vertically adjustable depending upon the wind velocity . . . the wind impinging upon helical vanes . . . when the wind velocity is high the power generating apparatus is automatically retracted into a well.”

In March 2002, U.S. Pat. No. 6,357,549 (Brennan et al.) disclosed “a method for servicing wind generating towers . . . attaching a guide rail climbing lifting platform . . . utilizing said platform to raise and lower wind generating turbine components.”

In June 2002, U.S. Pat. No. 6,408,575 (Yoshida et al.) disclosed “a horizontal axis type wind turbine having a tower mounted on a base, a nacelle mounted on said tower, and a rotor supported by said nacelle . . . . A method of lifting and mounting a nacelle of a horizontal axis type wind turbine . . . said nacelle is penetrated by said tower before lifting; lifting said nacelle along said tower with a plurality of tensile members vertically going through the interior of said tower and a plurality of pulleys provided in said tower.”

In 2008, U.S. Pat. No. 7,442,009 (Anel) disclosed “a wind turbine tower; a sleeve member slidably coupled to the tower; a wind turbine attached to the sleeve member. A gear motor coupled to the sleeve member . . . drives the gear in a clockwise direction to raise the sleeve member and the attached wind turbine toward the upper end of the tower. A locking mechanism . . . secures the sleeve member at an upper end of the tower and prevents the sleeve member from rotating with respect to the tower. The wind turbine is lowered so that the blades are received within a protective chamber.”

In 1970, U.S. Pat. No. 3,514,918 (Archer et al.) disclosed a method of pre-stressing a concrete column or utility pole. It uses interlocking telescoping sections, which are reinforced by pumping concrete in. Thus the tower is a permanent structure and built using telescoping sections of decreasing diameter

In 1981, U.S. Pat. No. 4,272,929 (Hanson) disclosed “a tower for a wind generator, made up of a plurality of segments where each segment fits into the one below it and is adjustable relative that lower segment. The lower segment is anchored in the ground . . . when cement is poured into the hole to anchor the tower, the cement flows up into the interior of the tower to give additional support.” While a tripod was used for the raising of the structure, it did not allow the rapid raising and lowering of the turbine in relation to the expected strength of the wind or for maintenance of the turbine. The tower was a permanent structure.

In 1997, WO 9721621 (Tymon) disclosed a method of raising a load, such as a turbine, upon a tower without the need of relatively heavy and expensive lifting apparatus. Thus the load is to remain in place at the top of the tower; although it may be lowered for maintenance. The tower had a traditional tapering structure and was a permanent structure.

In 2001, U.S. Published Application No. 2002047277 (Willis et al.) disclosed a tower with a sled movably mounted on guide rails. When the wind turbine has been positioned at the upper end of the tower, a horizontally slidable platform moves the wind turbine from the sled to the upper end of the tower so that the wind turbine may be secured to the upper end of the tower. A “self-propelled and steerable vehicle” may transport the sled from one tower location to another. While this system was designated for the management of wind farms, it did not include variable level turbine operation in relation to wind conditions and was a permanent structure.

In 2005, WO 2005028781 (Hiel et al.) disclosed a composite tower bearing one permanently emplaced wind turbine. The tower is built with telescoping sections of decreasing diameter, so that the turbines cannot be raised and lowered. Thus, this tower is a permanent structure.

In 2008, U.S. Published Application No. 20080078128 (Livingstone et al) disclosed a system for lifting a turbine upon a tower. The turbine is to remain affixed at the top of the tower unrelatedly to wind conditions with the tower itself being a permanent structure.

In 2011, U.S. Published Application No. 20110271608 (Egan et al.) disclosed how a tower will be built anchored to the ground. A lighter section is attached which will pivot upon the tower, thus raising the power units such as a turbine or other apparatus. The system allows for lowering the apparatus affixed to the top section for maintenance. However, lowering the turbine to the ground is not a rapid operation. It won't allow for lowering on a regular basis, such as when meteorological conditions dictate. The tower is a permanent structure.

In 2012, DE 102010031081 (Richert) disclosed a method of raising and lowering a horizontal axis turbine. The position of the turbine on the column will be automatically computer-controlled. This tower was not movable to another location. The invention does not discuss the method of building such a column, but allows the turbine to be lowered. Without previous removal of the blades, however, the turbine cannot be lowered all the way to the ground. To allow survival under serious storm conditions, the diameter of the column is unavoidably much greater than the smaller diameter that the present invention allows. Like some of the previous disclosures, the Richert concept allows the turbine to be lowered but not all the way to the ground without prior removal of the blades.

Most of the preceding inventions are plans for industrial turbines. A primary objective of this invention, by contrast, is to simplify the use of small turbines for: personal use by homeowners, isolated cabins in wooded areas and/or emergency situations.

### SUMMARY OF THE INVENTION

A rapidly retractable wind turbine system can be easily protected from storm damage. A wind turbine column is built using a tripod by joining together vertically positioned pipe elements. Thus a column is safely built.

The axis bearing the turbine is raised upon the column and can be rapidly lowered to the level appropriate for stronger than usual winds, storm situations, and/or turbine servicing. The invention was made with the intent to facilitate the installation and use of different models of vertical axis wind turbines. It may, however, also be used to facilitate the installation of lights or horizontal axis windmills.

### OBJECTS OF THE INVENTION

As discussed above, numerous inventions have disclosed methods of changing the level of a turbine to survive storms or to use wind energy more efficiently. However, said methods have so far been viewed as too cumbersome to be acceptable to the industry. It is normal to use cranes for the erection of towers and the turbines permanently mounted on such towers.

It is an object of this invention to provide:
a. a simplified method of erecting a column that will bear wind turbines upon an axis. This method is simplified in that it DOESN'T require a concrete base on which to mount. That makes the method of this invention significantly more “portable”, more useable and more adaptable. Small wind turbines can now be quickly erected for personal use, such as for one's own residence (and NOT the whole street, neighborhood or town) or on a more temporary basis, such as for one's own campground and/or vacation cabin. In the expectation of a storm (either forecast or observed), this axis can be safely and rapidly lowered to ground level thus avoiding damage to the column/to and its turbines.
b. a method for bringing turbines to an appropriate level for the strength of a given day's winds thus achieving greater efficiency.
c. a safer method of installing and maintaining wind turbines. This invention allows turbines to be brought to ground level for safer servicing without the need for cranes or climbing equipment. Fatal accidents are not rare events in the wind industry, accounting for more than eight casualties per year between 2008 and 2012. While no human activity is totally safe, the height of the machinery has been the most significant factor in producing casualties. A moment of inattention has led to workers being killed, sometimes by their own safety equipment.
d. the opportunity to use wind turbines in remote areas unreachable by cranes, to install temporary small turbines, and/or determine the eventual best location and expected energy production for a larger turbine installation.
e. an opportunity to better use vertical axis wind turbines which can be built in such a way as to be less of a threat to flying wildlife. Large numbers of endangered raptors and bats are killed by horizontal axis wind turbines.
f. the opportunity to use wind power in remote vacation areas (i.e., campgrounds and/or cabins) where theft of expensive equipment may be common. This invention addresses issues particular to remote summer cottages that are targeted by thieves in the off-season. It enables owners to remove their turbines and put them in secure storage.
g. the opportunity to install a wind turbine in one location, and then easily move it to a different location when vegetation growth requires relocation (without the need to cut down growing trees).
h. small, “personal use” wind turbines are not yet popular. Thus, should the sale of the house be necessary, the investment in a wind turbine is unlikely to increase the value of the house by an amount equal to the cost of the system. The portability of this invention allows use of a turbine system at a new location. The system is also appropriate for mobile homes.

No other previous inventions have proposed solutions for the problems that this invention proposes to solve.

### BRIEF DESCRIPTION OF THE DRAWINGS

FIG. 1 is a side schematic view of the wind turbine assembly of this invention;

FIGS. 1A and 1B present enlarged views of the respective circled areas 1A and 1B in FIG. 1, for better detailing aspects of that wind turbine assembly;

FIG. 2 is a side schematic view illustrating one method of constructing a column for supporting wind turbines according to this invention;

FIG. 2A shows the connection of the top segment of the column to the lifting rope or cable as per the enlarged circle region 2A in FIG. 2;

FIG. 2B shows the method of connecting segments to each other, by means of inserts as per the enlarged circle region 2B in FIG. 2;

FIG. 3 is a side schematic view of the wind turbine assembly illustrating position of the turbines for servicing;

FIG. 4 is a side schematic view of the turbine assembly in a more stable and solid configuration;

FIG. 5 is a side schematic view of a four-turbine configuration;

FIG. 6 is a side schematic view of an alternative embodiment showing how a plurality of lesser diameter columns can be used to create a stronger larger diameter column that will support an axis bearing heavier turbines; and

FIG. 6A is a front perspective view of the circled region 6A in FIG. 6, showing a top section of that column as seen from a point 30 degrees above horizontal.

### DESCRIPTION OF PREFERRED EMBODIMENTS

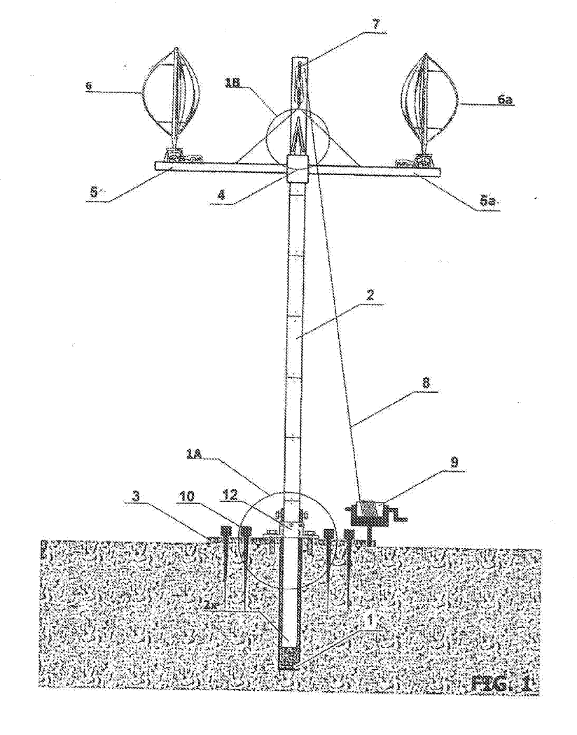

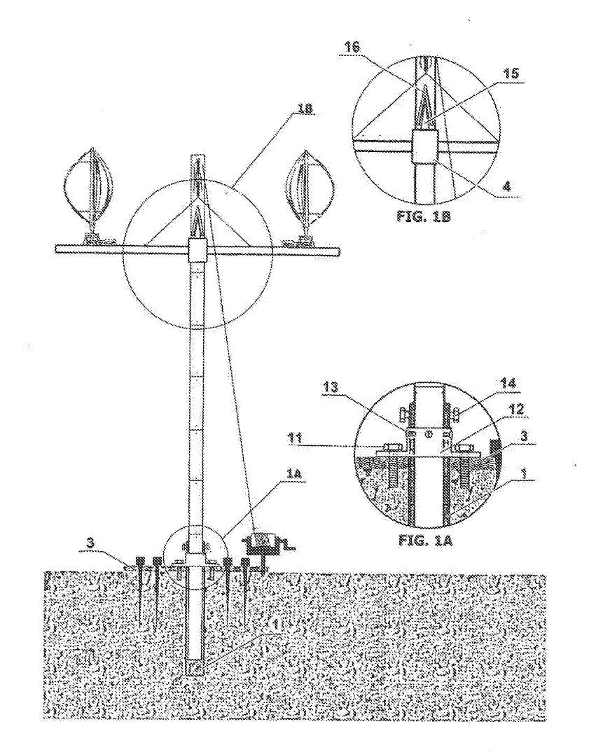

Referring to FIG. 1 (page 1 of 8), a side view shows a pipe 1, which was dropped into a hole drilled in the ground. A steel plate 3 with a central round opening is lowered over the part of pipe 1 that remains above ground.

Referring to FIG. 1A (page 2 of 8), a side view shows a pipe 1 and plate 3 joined by coupling 12, the latter being bolted to 1 and 3 by means of screws 13 and 11. The function of screw 14 is to prevent eventual rotation of column 2 in the wind.

Referring to FIG. 1 (page 1 of 8), a side view shows the unit of pipe, coupling, and steel plate being stabilized by multiple spikes 10 which were inserted into holes in the steel plate 3 and hammered into the ground.

Referring to FIG. 1 (page 1 of 8), a side view shows how sections 5 and 5a are welded or bolted at a right angle to collar 4, said sections being formed by a section of pipe whose diameter is similar to that of pipe 1. Hence, this axis is formed by a combination of elements 4, 5, and 5a.

Referring to FIG. 1B (page 2 of 8), a side view shows how when the axis has been raised to the top of column 2, wedge 15, welded onto collar 4, engages inverted V-shaped configuration 16, welded into the top section of the column. That arrangement should prevent the turbine axis from rotating in the wind.

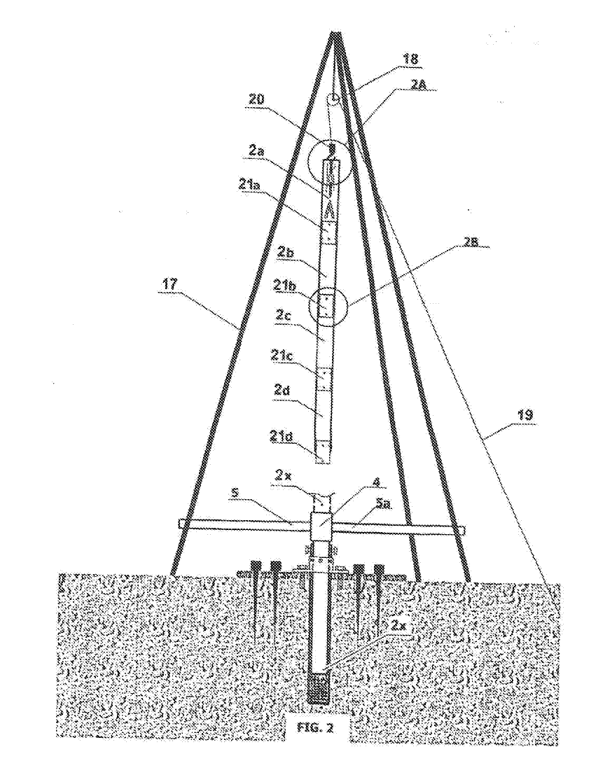

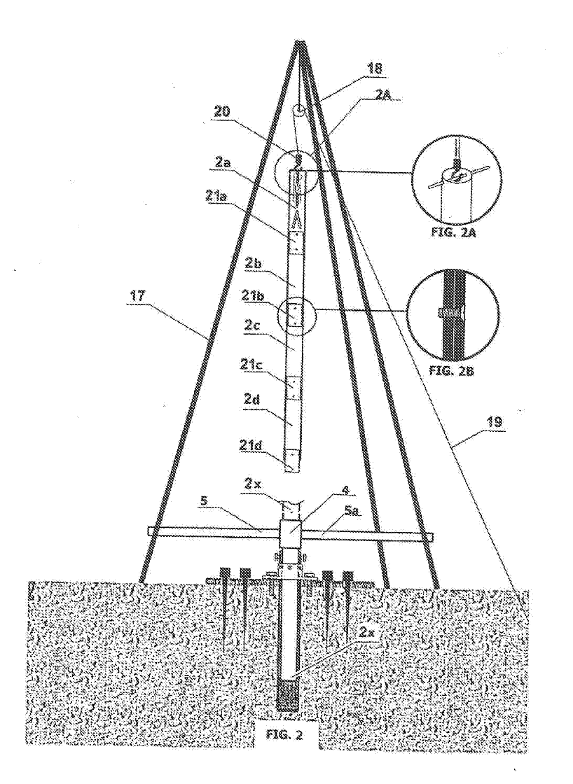

Referring to FIG. 2 (page 3 of 8), a side view shows how a light metal or carbon fiber tripod (or similar multi-legged lifting apparatus) 17 that is taller than the intended column can be erected over the work site. It is intended to lift and stabilize the column during construction.

Referring to FIG. 2 (page 3 of 8), a side view shows how cable 19 passes through a pulley 18.

Referring to FIG. 2A (page 4 of 8), a side view from 30 degrees above the horizontal shows how the first section 2a of column 2 is held aloft by hook 20.

Referring to FIG. 2 (page 3 of 8), a side view shows how column section 2a is raised high enough to allow the second section 2b of column 2 to be connected to the first section 2a by means of an internal sleeve 21a. In the same way, further sections can be added thereto until the column has reached its desired height.

Referring to FIG. 2 (page 3 of 8), a side view shows the bottom section 2x of column 2 already inserted into collar 4 of the axis and into pipe 1 already buried in the ground. The other column sections, still held aloft by the tripod, must now be lowered and be connected to element 2x. Then the column will be complete and unhooked from tripod 17. This column will then be freestanding and able to withstand very high winds so long as it does not carry an additional load or provide a greater wind aspect.

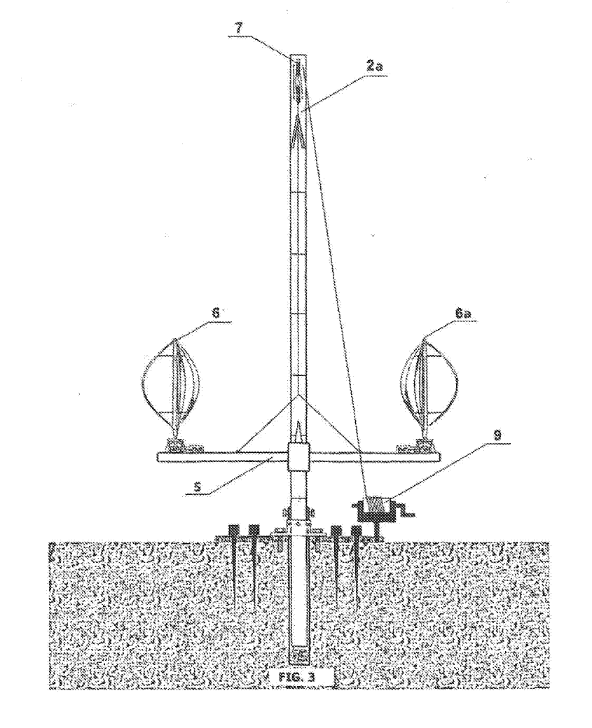

Referring to FIG. 3 (page 5 of 8), the turbines are safely available for servicing at ground level. This side view shows turbines ready to be raised as required, possibly using a winch and pulley system 7 such as the one built into section 2a or the top section of this column. Such pulleys can be integral to a new column construction or added, after the fact, as an after-market option, in the alternative.

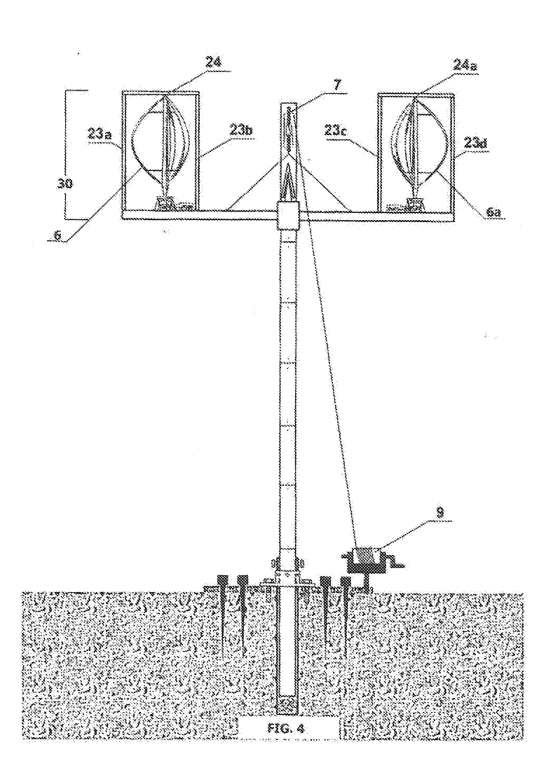

Referring to FIG. 4 (page 6 of 8), a side view shows another embodiment of the present invention in which set 30 is composed of twin turbines 6 and 6a framed by bars 23a, 24, 23b, 23c, 24a, and 23d. Ball bearing assemblies connect turbines to bars 24 and 24a. Thus the wind turbine is given stability and the wear on its ball bearings decreased.

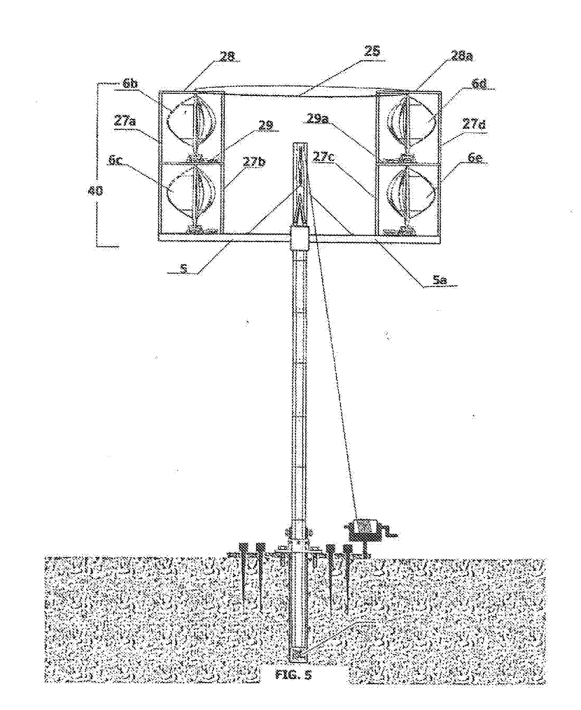

Referring to FIG. 5 (page 7 of 8), a side view shows another embodiment of the present invention: set 40, is composed of four framed turbines 6b, 6c, 6d and 6e, installed upon beams 5 and 5a, which are then framed by bars 27a, 27b, 27c, 27d, 28, 28a, 29, and 29a. Wobbling may be further decreased by connecting two horizontal bars 28 and 28a with a circular brace 25.

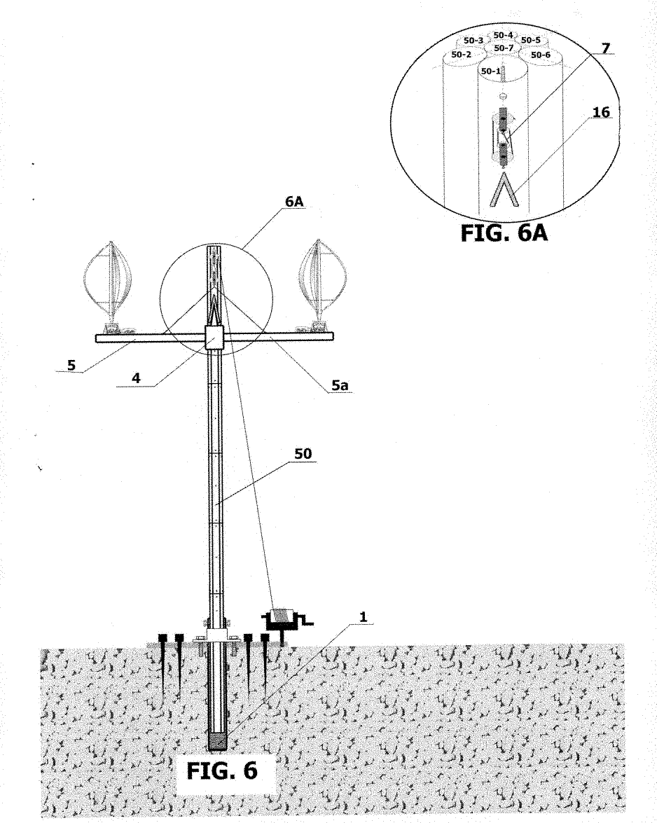

Referring to FIG. 6 (page 8 of 8), a side view shows another embodiment of the present invention in which a method to install turbines of a greater weight is disclosed. Using larger diameter pipe to construct the column would disallow the use of a lightweight tripod to raise the column. To avoid the complications and cost of a crane, the required column 50 may be formed by constructing a plurality of columns of lesser diameter.

Referring to FIG. 6A, a side view as seen from a point at 30 degrees above the horizontal shows a plurality of lesser diameter columns combined to create a single column. Lesser diameter columns 50.1, 50.2, 50.3, 50.4, 50.5, 50.6, and 50.7 may be separately raised and stabilized with tripod 17. These lesser diameter columns may be separately inserted: first into the axis formed by elements 5, 4, and 5a; then into pipe 1.

Referring to FIG. 6 (and enlarged FIG. 6A), side views shows how each of the columns of lesser diameter (50-1 to 50-6) are bolted to the central lesser diameter column 50-7. Together they form a composite column 50 upon which collar 4 and the attached axis bearing heavier turbines may be raised. Column 50.1 bears pulley 7 and V-shaped slot 16.

1. A method for mounting one or more, small personal use wind turbines on a column without need for a concrete base, said method comprising steps of:
providing a first pipe segment adapted for inserting into a hole drilled into a ground surface;
bolting said first pipe segment to a steel plate to form the column onto which the one or more wind turbines will be mounted; and
stabilizing the column with multiple spikes, each spike being inserted through a hole in the steel plate and hammered into the ground surface.

2. The method of claim 1, which further comprises:
joining two metal segments to a second pipe segment for building an axle onto which to mount said one or more wind turbines.

3. The method of claim 2 wherein the first pipe segment and the second pipe segment have a same diameter.

4. The method of claim 2 wherein each of the two metal segments are joined at a right angle to the second pipe segment.

5. The method of claim 1 wherein the one or more wind turbines are adapted for raising and lowering on the column prior to a storm.

6. The method of claim 5 wherein the one or more wind turbines are adapted for raising and lowering on the column manually or mechanically.

7. The method of claim 5 which further includes:
providing a winch and pulley system for raising and lowering the wind turbines.

8. The method of claim 7 wherein said winch and pulley system is built into a top section of the column.

9. The method of claim 1 wherein the one or more wind turbines are adapted for raising and lowering on the column for maintenance.

10. The method of claim 1 wherein the one or more wind turbines are adapted for raising and lowering on the column for removal and storage.

11. The method of claim 1 wherein the one or more wind turbines are adapted for residential use.

12. The method of claim 1 wherein the one or more wind turbines are adapted for temporary campground use.

13. A method for safely mounting a small, personal use wind turbine on a column without need of a concrete base for the column, said method comprising the steps of:
providing a first pipe segment adapted for inserting into a hole drilled into a ground surface;
bolting said first pipe segment to a steel plate to form the column onto which the wind turbine will be mounted;
stabilizing the column with multiple spikes, each spike being inserted through a hole in the steel plate and hammered into the ground surface; and
joining two metal segments to a second pipe segment for building an axle onto which to mount said wind turbine.

14. The method of claim 13 which further includes:
providing a winch and pulley system for raising and lowering the wind turbine.

15. The method of claim 14 wherein said winch and pulley system is built into a top section of the column.
